(19) United States
(12) Patent Application Publication
(10) Pub. No.: US 2025/0162588 A1
(43) Pub. Date: May 22, 2025

(54) DRIVING ASSISTANCE APPARATUS

(71) Applicant: Honda Motor Co., Ltd., Tokyo (JP)

(72) Inventors: Nana Niibo, Saitama (JP); Tomotaka Teramachi, Saitama (JP)

(21) Appl. No.: 18/836,680

(22) PCT Filed: Feb. 14, 2022
(86) PCT No.: PCT/JP2022/005565

§ 371 Date: Jan. 31, 2025

(51) Int. Cl. B60W 30/18

(52) U.S. Cl. CPC B60W 30/18163; B60W 2540/215; B60W 2552/10; B60W 2552/53; B60W 2554/4041; B60W 2554/802

(57) ABSTRACT

A driving assistance apparatus including a microprocessor controlling an actuator for travel so that an inter-vehicle distance between a subject vehicle and a preceding vehicle is a predetermined value or more, and so as to perform a lane change operation from a first lane to a second lane when a lane change command is output and so as to return to the first lane when a cancellation command is output after a start of the lane change operation. The preceding vehicle includes a first preceding vehicle traveling on the first lane and a second preceding vehicle traveling on the second lane. The microprocessor sets at least one of the first and second preceding vehicles as a control target based on a return travel path for the subject vehicle when the cancellation command is output and the subject vehicle returns to the first lane.

### TECHNICAL FIELD

This invention relates to a driving assistance apparatus assisting an operation when a vehicle changes a lane.

### BACKGROUND ART

As this type of apparatus, conventionally, after a start of assistance control for lane changing from a current lane to an adjacent lane, if another vehicle abnormally approaches the subject vehicle, an apparatus is known that controls the vehicle's traveling operation to cancel the lane change and return to the current lane (see Patent Literature 1, for example).

### CITATION LIST

### Patent Literature

Patent Literature 1: Japanese Examined Patent Publication No. 6760204

### DISCLOSURE OF INVENTION

### Problems to be Solved by the Invention

By the way, the manner in which the subject vehicle approaches a preceding vehicle traveling ahead differs between when the lane change is canceled and when the lane change is executed without being canceled. Therefore, it is desirable to provide specific driving assistance at the time of lane change cancellation, assuming the presence of the preceding vehicle.

### Means for Solving Problem

An aspect of the present invention is a driving assistance apparatus including an external detection part configured to detect an external situation around a subject vehicle, a command part configured to output a lane change command from a first lane on which the subject vehicle travels to a second lane adjacent to the first lane through a division line and a cancellation command of the lane change, and a driving control unit configured to control an actuator for traveling so that an inter-vehicle distance between the subject vehicle and a preceding vehicle traveling ahead of the subject vehicle and detected by the external detection part is equal to or more than a predetermined value, with the preceding vehicle as a control target for the subject vehicle, and when the lane change command is output from the command part, to control the actuator so as to perform a lane change operation changing a lane from the first lane to the second lane, and further after a start of the lane change operation, when the cancellation command of the lane change is output from the command part before a completion of the lane change operation, to control the actuator so as to return to the first lane. The preceding vehicle includes a first preceding vehicle traveling on the first lane and a second preceding vehicle traveling on the second lane. The driving control unit is configured to set at least one of the first preceding vehicle and the second preceding vehicle as the control target based on a return travel path for the subject vehicle when the cancellation command of the lane change is output and the subject vehicle returns to the first lane.

An another aspect of the present invention is a driving assistance apparatus including an external detection part configured to detect an external situation around a subject vehicle, a command part configured to output a lane change command from a first lane on which the subject vehicle travels to a second lane adjacent to the first lane through a division line and a cancellation command of the lane change, and a driving control unit configured to control an actuator for traveling so that an inter-vehicle distance between the subject vehicle and a preceding vehicle traveling ahead of the subject vehicle and detected by the external detection part is equal to or more than a predetermined value, with the preceding vehicle as a control target for the subject vehicle, and when the lane change command is output from the command part, to control the actuator so as to perform a lane change operation changing a lane from the first lane to the second lane, and further after a start of the lane change operation, when the cancellation command of the lane change command is output from the command part before a completion of the lane change operation, to control the actuator so as to return to the first lane. The preceding vehicle includes a first preceding vehicle traveling on the first lane and a second preceding vehicle traveling on the second lane. The driving control unit is configured to switch the control target between the first preceding vehicle ant the second preceding vehicle in accordance with a change of a travel lane for the subject vehicle between the first lane and the second lane.

### Effect of the Invention

According to the present invention, it is possible to perform an appropriate driving assistance during lane change cancellations.

### BRIEF DESCRIPTION OF THE DRAWINGS

FIG. 1 is a block diagram schematically illustrating an overall configuration of a vehicle control system for a self-driving vehicle having a driving assistance apparatus according to an embodiment of the present invention;

FIG. 2A is a diagram illustrating an example of procedure for a lane change operation to which the driving assistance apparatus according to the embodiment of the present invention is applied;

FIG. 2B is a diagram illustrating an example of procedure for a lane change cancellation operation to which the driving assistance apparatus according to the embodiment of the present invention is applied;

FIG. 3A is a diagram illustrating an example of an operation during lane change cancellation in the driving assistance apparatus according to the embodiment of the present invention;

FIG. 3B is a diagram illustrating another example of an operation during lane change cancellation in the driving assistance apparatus according to the embodiment of the present invention;

FIG. 3C is a diagram illustrating an example of an operation when lane change cannot be canceled in the driving assistance apparatus according to the embodiment of the present invention;

FIG. 4 is a block diagram illustrating main configurations of the driving assistance apparatus according to the embodiment of the present invention; and

FIG. 5 is a flowchart illustrating an example processing executed by a controller in FIG. 4.

### DESCRIPTION OF EMBODIMENT

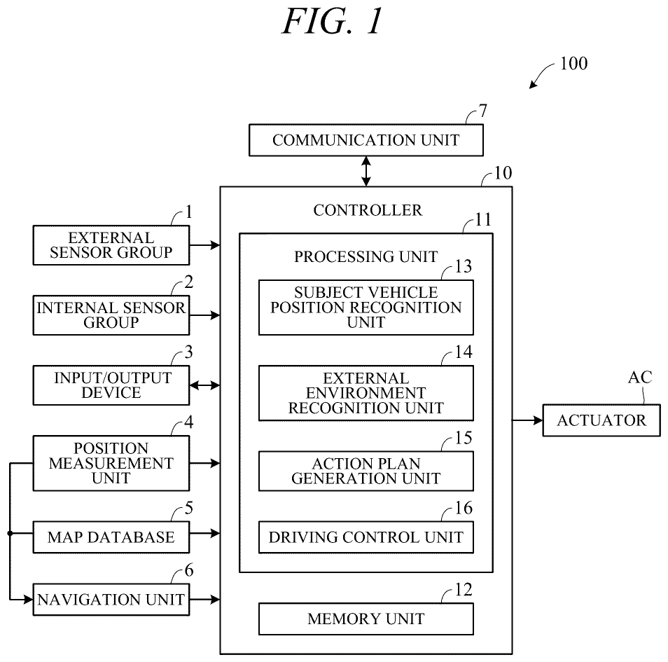

Now, an embodiment of the present invention will be described with reference to FIGS. 1 to 5. A driving assistance apparatus according to the embodiment of the present invention can be applied to a vehicle having a self-driving capability, i.e., a self-driving vehicle and a manual driving vehicle not having the self-driving capability. Hereinafter, an example in which the driving assistance apparatus is applied to the self-driving vehicle is described. The vehicle to which the driving assistance apparatus according to the embodiment is applied may be sometimes called “a subject vehicle” to differentiate it from other vehicles.

The subject vehicle is an engine vehicle having an internal combustion engine (engine) as a travel drive source, electric vehicle having a travel motor as the travel drive source, or hybrid vehicle having both of the engine and the travel motor as the travel drive source. The subject vehicle (self-driving vehicle) can travel not only in a self-drive mode in which a driving operation by a driver is unnecessary, but also in a manual drive mode in which the driving operation by the driver is necessary.

First, the general configuration for self-driving will be explained. FIG. 1 is a block diagram schematically illustrating an overall configuration of a vehicle control system 100 having a division assistance apparatus according to an embodiment of the present invention. As shown in FIG. 1, the vehicle control system 100 mainly includes a controller 10, and an external sensor group 1, an internal sensor group 2, an input/output device 3, a position measurement unit 4, a map database 5, a navigation unit 6, a communication unit 7 and actuators AC for traveling which are communicably connected with the controller 10.

The term external sensor group 1 herein is a collective designation encompassing multiple sensors (external sensors) for detecting external circumstances constituting subject vehicle ambience data. For example, the external sensor group 1 includes, inter alia, a LiDAR (Light Detection and Ranging) for detecting positions (distance and direction from the subject vehicle) of objects around the subject vehicle by radiating laser light and detecting the reflected light, a RADAR (Radio Detection and Ranging) for detecting positions of objects around the subject vehicle by radiating electromagnetic waves and detecting the reflected waves, and a camera having a CCD, CMOS or other image sensor for imaging subject vehicle ambience. The LiDAR and the radar can detect objects within an image area of the camera.

The term internal sensor group 2 herein is a collective designation encompassing multiple sensors (internal sensors) for detecting driving state of the subject vehicle. For example, the internal sensor group 2 includes, inter alia, a vehicle speed sensor for detecting vehicle speed of the subject vehicle, acceleration sensors for detecting forward-rearward direction acceleration and lateral acceleration of the subject vehicle, respectively, rotational speed sensor for detecting rotational speed of the travel drive source and the like. The internal sensor group 2 also includes sensors for detecting driver driving operations in manual drive mode, including, for example, accelerator pedal operations, brake pedal operations, steering wheel operations and the like.

The term input/output device 3 is used herein as a collective designation encompassing apparatuses receiving instructions input by the driver and outputting information to the driver. The input/output device 3 includes, inter alia, switches which the driver uses to input various instructions, a microphone which the driver uses to input voice instructions, a display for presenting information to the driver via displayed images, and a speaker for presenting information to the driver by voice.

The position measurement unit (GNSS unit) 4 includes a position measurement sensor for receiving signal from positioning satellites to measure the location of the subject vehicle. The position measurement sensor may be included in the internal sensor group 2. The positioning satellites are satellites such as GPS satellites and Quasi-Zenith satellite. The position measurement unit 4 measures absolute position (latitude, longitude and the like) of the subject vehicle based on signal received by the position measurement sensor.

The map database 5 is a unit storing general map data used by the navigation unit 6 and is, for example, implemented using a hard disk or semiconductor element. The map data include road position data and road shape (curvature etc.) data, along with intersection and road branch position data. The map data stored in the map database 5 are different from high-accuracy map data stored in a memory unit 12 of the controller 10.

The navigation unit 6 retrieves target road routes to destinations input by the driver and performs guidance along selected target routes. Destination input and target route guidance is performed through the input/output device 3. Target routes are computed based on current position of the subject vehicle measured by the position measurement unit 4 and map data stored in the map database 35. The current position of the subject vehicle can be measured, using the values detected by the external sensor group 1, and on the basis of this current position and high-accuracy map data stored in the memory unit 12, target route may be calculated.

The communication unit 7 communicates through networks including the Internet and other wireless communication networks to access servers (not shown in the drawings) to acquire map data, travel history information, traffic data and the like, periodically or at arbitrary times. The networks include not only public wireless communications network, but also closed communications networks, such as wireless LAN, Wi-Fi (registered trademark) and Bluetooth (registered trademark), which are established for a predetermined administrative area. Acquired map data are output to the map database 5 and/or memory unit 12 via the controller 10 to update their stored map data.

The actuators AC are actuators for traveling of the subject vehicle. If the travel drive source is the engine, the actuators AC include a throttle actuator for adjusting opening angle of the throttle valve of the engine (throttle opening angle). If the travel drive source is the travel motor, the actuators AC include the travel motor. The actuators AC also include a brake actuator for operating a braking device and turning actuator for driving a turning device.

The controller 10 is constituted by an electronic control unit (ECU). More specifically, the controller 10 incorporates a computer including a CPU or other processing unit (a microprocessor) 11 for executing a processing in relation to travel control, the memory unit (a memory) 12 of RAM, ROM and the like, and an input/output interface or other peripheral circuits not shown in the drawings. In FIG. 1, the controller 10 is integrally configured by consolidating multiple function-differentiated ECUs such as an engine control ECU, a transmission control ECU and so on. Optionally, these ECUs can be individually provided.

The memory unit 12 stores high-accuracy detailed road map information. The road map information includes information on road position, information on road shape (curvature, etc.), information on gradient of the road, information on position of intersections and branches, information on the number of lanes, information on width of lane and the position of each lane (center position of lane and boundary line of lane), information on position of landmarks (traffic lights, signs, buildings, etc.) as a mark on the map, and information on the road surface profile such as unevennesses of the road surface, etc. The map information stored in the memory unit 12 includes map information acquired from the outside of the subject vehicle through the communication unit 7, and map information created by the subject vehicle itself using the detection values of the external sensor group 1 or the detection values of the external sensor group 1 and the internal sensor group 2.

The processing unit 11 includes a subject vehicle position recognition unit 13, an external environment recognition unit 14, an action plan generation unit 15, and a driving control unit 16, as functional configurations.

The subject vehicle position recognition unit 13 recognizes the position of the subject vehicle (subject vehicle position) on the map based on position information of the subject vehicle calculated by the position measurement unit 4 and map information stored in the map database 5. Optionally, the subject vehicle position can be recognized using map information stored in the memory unit 12 and ambience data of the subject vehicle detected by the external sensor group 1, whereby the subject vehicle position can be recognized with high accuracy. Optionally, when the subject vehicle position can be measured by sensors installed externally on the road or by the roadside, the subject vehicle position can be recognized with high accuracy by communicating with such sensors through the communication unit 7.

The external environment recognition unit 14 recognizes external circumstances around the subject vehicle based on signals from cameras, LiDARs, radars and the like of the external sensor group 1. For example, it recognizes position, speed and acceleration of nearby vehicles (forward vehicle or rearward vehicle) driving in the vicinity of the subject vehicle, position of vehicles stopped or parked in the vicinity of the subject vehicle, and position and state of other objects. Other objects include traffic signs, traffic lights, road division lines and stop lines, buildings, guardrails, power poles, commercial signs, pedestrians, bicycles, and the like. Recognized states of other objects include, for example, traffic light color (red, green or yellow) and moving speed and direction of pedestrians and bicycles.

The action plan generation unit 15 generates a travel path (target path) of the subject vehicle from present time point to a certain time ahead based on, for example, a target route computed by the navigation unit 6, map information stored in the memory unit 12, subject vehicle position recognized by the subject vehicle position recognition unit 13, and external circumstances recognized by the external environment recognition unit 14. When multiple paths are available on the target route as target path candidates, the action plan generation unit 15 selects from among them the path that optimally satisfies legal compliance, safe efficient driving and other criteria, and defines the selected path as the target path. The action plan generation unit 15 then generates an action plan matched to the generated target path. An action plan is also called “travel plan”. The action plan generation unit 15 generates various kinds of action plans corresponding to overtake traveling for overtaking the forward vehicle, lane-change traveling to move from one traffic lane to another, following traveling to follow the preceding vehicle, lane-keep traveling to maintain same lane, deceleration or acceleration traveling. When generating a target path, the action plan generation unit 15 first decides a drive mode and generates the target path in line with the drive mode.

In self-drive mode, the driving control unit 16 controls the actuators AC to drive the subject vehicle along target path generated by the action plan generation unit 15. More specifically, the driving control unit 16 calculates required driving force for achieving the target accelerations of sequential unit times calculated by the action plan generation unit 15, taking running resistance caused by road gradient and the like into account. And the driving control unit 16 feedback-controls the actuators AC to bring actual acceleration detected by the internal sensor group 2, for example, into coincidence with target acceleration. In other words, the driving control unit 16 controls the actuators AC so that the subject vehicle travels at target speed and target acceleration. On the other hand, in manual drive mode, the driving control unit 16 controls the actuators AC in accordance with driving instructions by the driver (steering operation and the like) acquired from the internal sensor group 2.

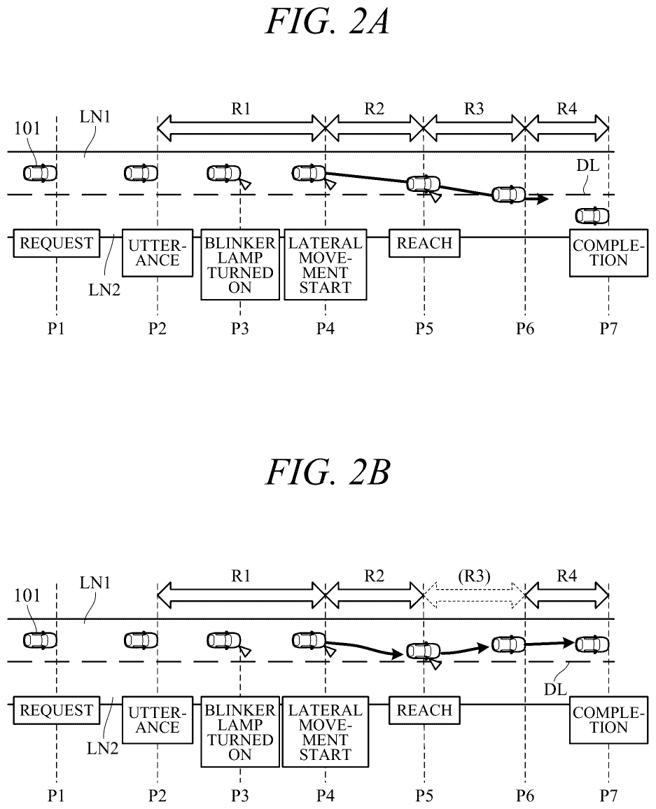

The driving assistance apparatus according to the embodiment is characterized in a driving assistance during lane change traveling. FIG. 2A is a diagram illustrating an example of a travel scene in which the subject vehicle 101 traveling on the first lane LN1 in the self-drive mode, changes lane to the second lane LN2 adjacent to the first lane LN1. The first lane LN1 and the second lane LN2 are partitioned by a division line DL which is a boundary line, and the subject vehicle 101 changes lane across the division line DL. The travel lane before lane change (first lane LN1) may be referred to as a current lane, and the travel lane planned for lane change (second lane LN2) may be referred to as an adjacent lane.

In the present embodiment, the lane change traveling (automatic lane change traveling) can be realized in three different modes (first mode, second mode, and third mode).

In the first mode, the lane change is performed when a lane change command is input from a driver. More specifically, when the lane change command is input from the driver, the vehicle control system 100 determines whether the lane change can be performed based on the surrounding situation. When it is determined that the lane change can be performed, the controller 10 of the vehicle control system 100 controls the actuator AC to perform the lane change from the first lane LN1 to the second lane LN2.

In the second mode, the lane change is performed when a lane change command is input from the vehicle control system 100. More specifically, when proposal information for lane change is input as the lane change command, the controller 10 of the vehicle control system 100 controls the input/output device 3 (speaker, display, or the like) to notify the driver of information for lane change approval request. Then, when the driver approves the lane change, the controller 10 controls the actuator AC to perform the lane change from the first lane LN1 to the second lane LN2.

In the third mode, when a lane change command is input from the vehicle control system 100, the lane change is performed from the first lane LN1 to the second lane LN2 without requiring the driver's approval for the lane change.

The driving assistance apparatus of the present embodiment is applicable to any of the lane change modes: the first mode, the second mode, and the third mode. However, hereinafter, a configuration of the driving assistance apparatus will be described using a case where the lane change is performed in the first mode while the actuator AC is controlled (following traveling control) to follow a preceding vehicle traveling in front of the subject vehicle 101 as an example. Before the lane change operation is performed, the traveling operation of the subject vehicle 101 is controlled so that the subject vehicle 101 travels in the middle of the travel lane in the lane width direction.

As illustrated in FIG. 2A, in the first mode, a lane change command (request command for lane change) is input from the driver at a point P1. The lane change command is input by operating a blinker lever at a driver's seat, for example. This operation is different from a turning operation from a neutral position when the subject vehicle 101 is turned right or left in a manual drive mode. For example, when the blinker lever is held for a predetermined time while turned from a neutral position to a predetermined position, the lane change command is input. When the lane change command is input, the vehicle control system 100 performs the lane change according to the following procedure.

First, at a point P2 after a predetermined time has elapsed since the output of the request command for the lane change, a control signal is output to a vehicle interior speaker (input/output device 3), and a vocal sound indicating that the lane change command has been received is output from the speaker (utterance). As a result, the driver can recognize that the lane change will be automatically performed without performing steering or an acceleration/deceleration operation. Next, at a point P3 after a predetermined time has elapsed since the occurrence of the utterance, a blinker lamp of the subject vehicle 101 on the second lane LN2 side (right side) is turned on (blinks). Next, at a point P4 after a predetermined time has elapsed since the turning on of the blinker lamp, it is recognized that there is a sufficient space for the lane change to the second lane LN2 based on a signal from an external sensor group 1, and then a control signal is output to the actuator AC to start the movement of the subject vehicle 101 to the second lane LN2 side, that is, the lateral movement.

When a lane change cancellation command is input between the point P2 and the point P4, the subject vehicle 101 stops the lane change without starting the lateral movement. A section R1 from the point P2 to the point P4 before the start of the lateral movement is referred to as a first cancellable section for convenience. In the first cancellable section R1, the lane change is canceled without return traveling of the subject vehicle 101 to a center position of the first lane LN1 in the lane width direction. After the lane change is stopped, a control signal is output to the actuator AC to follow the preceding vehicle traveling on the first lane LN1.

The lane change cancellation command is input by a driver's operation or based on the determination made by the controller 10. For example, after the start of the lateral movement or immediately before the start of the lateral movement, when the external sensor group 1 detects that another vehicle coming from behind on the second lane LN2 is approaching suddenly, the lane change cancellation command is input, and the vehicle control system 100 cancels the lane change. The cancellation command is also input in a case where the driver performs steering, an acceleration/deceleration operation, a blinker lever operation, or the like.

When the subject vehicle 101 approaches a division line DL by a predetermined degree or more at a point P5 in FIG. 2A with no input of the lane change cancellation command, the lane change cannot be canceled. In this case, the controller 10 controls the actuator AC so that the subject vehicle 101 moves to (reaches) the second lane LN2. The lane change can be canceled up to the point P5, and a section R2 from the point P4 to the point P5 is referred to as a second cancellable section for convenience.

When no cancellation command is input in the second cancellable section R2, the subject vehicle 101 moves to (reaches) the second lane LN2 across the division line DL from the point P5 to a point P6. Further, at a point P7, the subject vehicle 101 moves to a center position of the second lane LN2 in the lane width direction, and the lane change is completed. After the lane change is completed, the controller 10 controls the actuator AC to follow the preceding vehicle traveling on the second lane LN2. A section R3 from the point P5 to the point P6 is referred to as a reaching section for convenience, and a section R4 from the point P6 to the point P7 after completion of the reaching is referred to as an adaptive cruise control (ACC) section for convenience. In the ACC section R4, the actuator AC is controlled so that the inter-vehicle distance to the preceding vehicle becomes a predetermined distance according to the vehicle speed.

FIG. 2B is a diagram illustrating an example of a travel scene in a case where a lane change cancellation command is input in the second cancellable section R2 before the subject vehicle 101 reaches the second lane LN2. As illustrated in FIG. 2B, when a lane change cancellation command is input in the second cancellable section R2, the controller 10 controls the actuator AC so that the subject vehicle 101 returns to the center position of the first lane LN1 in the lane width direction. Thereafter, the actuator AC is controlled to follow the preceding vehicle on the first lane LN1 in the ACC section R4 after the point P6.

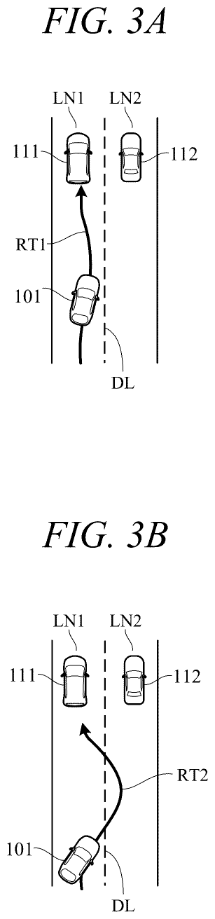

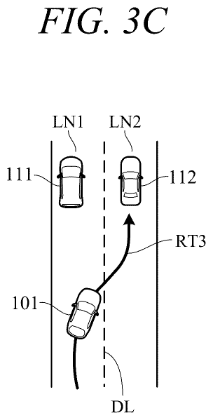

FIGS. 3A to 3C are diagrams each illustrating an example of an operation after the start of the lane change operation (lateral movement) of the subject vehicle 101. In FIGS. 3A to 3C, unlike FIGS. 2A and 2B, preceding vehicles 111 and 112 are shown in front of the subject vehicle 101. That is, the first preceding vehicle 111 traveling on the first lane LN1 and the second preceding vehicle 112 traveling on the second lane LN2 are shown. In FIGS. 3A to 3B, the two preceding vehicles 111 and 112 are positioned at the same positions or substantially the same positions in the traveling direction and run in parallel.

FIGS. 3A and 3B are examples of a case where a cancellation command is input in the second cancellable section R2. In particular, FIG. 3A is an example in which the subject vehicle 101 returns along a travel path RT1 without crossing the division line DL. Meanwhile, FIG. 3B is an example in which the subject vehicle 101 returns along a travel path RT2 while crossing the division line DL, and is an example of a case where a lane change cancellation command is input immediately before the point P5 in FIG. 2B. In this case, it is not preferable to suddenly change the traveling posture (direction) of the subject vehicle 101 since the behavior of the vehicle 101 becomes unstable. Therefore, as illustrated in FIG. 3B, the subject vehicle 101 returns while crossing the division line DL.

FIG. 3C is an example of a case where a cancellation command is input in the reaching section R3. That is, FIG. 3C is a diagram illustrating an example of an operation when the lane change cannot be canceled. In FIG. 3C, the subject vehicle 101 does not return and changes the lane along a travel path RT3.

In the lane change operation, a target vehicle to be followed is set. Therefore, when the lane change is canceled and the subject vehicle 101 returns, the subject vehicle 101 returns while following the preceding vehicle, and the inter-vehicle distance between the subject vehicle 101 and the preceding vehicle can be appropriately maintained during the return traveling. However, as illustrated in FIGS. 3A and 3B, the travel path during the return traveling may or may not cross the division line DL. The case where the travel path crosses the division line DL includes a case where the travel path and the division line DL intersect and a case where the distance between the travel path and the division line is a predetermined value or less. The case where the travel path does not cross the division line includes a case where the travel path and the division line DL do not intersect and a case where the travel path and the division line DL do not intersect and the distance between the travel path and the division line DL is larger than a predetermined value.

If the target vehicle during the return traveling is set (for example, the first preceding vehicle 111 is set as a target vehicle) without considering the fact that there are a case where the travel path crosses the division line DL during the return traveling and a case where the travel path does not cross the division line DL during the return traveling, the subject vehicle 101 may return while approaching the preceding vehicle (second preceding vehicle 112) that is not set as a target vehicle. As a result, the driver's uneasiness increases. In addition, as illustrated in FIG. 3C, even in a case where the subject vehicle 101 performs the lane change, the driver's uneasiness may increase if the target vehicle is not set appropriately. Therefore, in order to realize the operation during the lane change without increasing the driver's uneasiness, the driving assistance apparatus according to the present embodiment is configured as below.

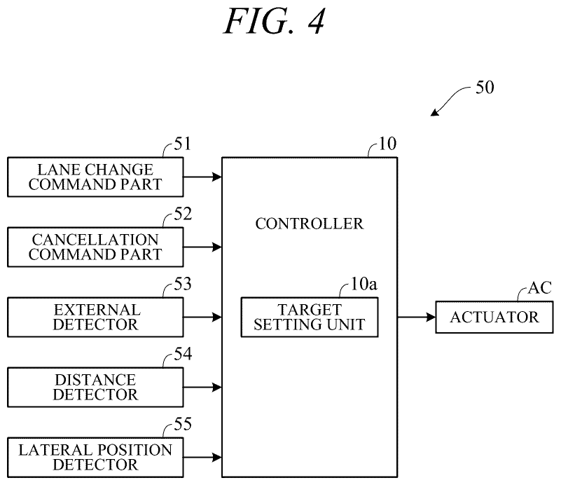

FIG. 4 is a block diagram illustrating a configuration of a main part of the driving assistance apparatus 50 according to the embodiment of the present invention. The driving assistance apparatus 50 is included in the vehicle control system 100 in FIG. 1. As illustrated in FIG. 4, the driving assistance apparatus 50 mainly includes a lane change command part 51, a cancellation command part 52, an external detector 53, a distance detector 54, a lateral position detector 55, the controller 10, and the actuator AC. The controller 10 mainly functions as the action plan generation unit 15 and the driving control unit 16 in FIG. 1.

The lane change command part 51 outputs a lane change command in response to a driver's operation, and is configured by, for example, a switch that is operated by operating the blinker lever. That is, the lane change command is input when a predetermined time has elapsed while the driver turns the blinker lever from the neutral position to the predetermined position, and the lane change command part 51 is configured to detect the operation when the lane change is instructed.

The cancellation command part 52 outputs a lane change cancellation command after the lane change command is input by the lane change command part 51, and is configured by, for example, the external sensor group 1 and the external environment recognition unit 14 in FIG. 1. That is, when the external environment recognition unit 14 recognizes another vehicle suddenly approaching the subject vehicle 101 from behind on the second lane LN2 based on a signal from the external sensor group 1, a cancellation command is output. The cancellation command can also be output by the driver performing steering, an acceleration/deceleration operation, or the like. Therefore, the cancellation command part 52 can also be configured by the internal sensor group 2 that detects these operations.

The external detector 53 detects an external situation around the subject vehicle 101, and is configured by, for example, a camera included in the external sensor group 1 in FIG. 1. The first preceding vehicle 111, the second preceding vehicle 112, the division line DL, and the like can be detected by the external detector 53.

The distance detector 54 detects an inter-vehicle distance from the subject vehicle 101 to the preceding vehicle 111 or 112, and is configured by, for example, a radar or a LiDAR included in the external sensor group 1 in FIG. 1. During following traveling, the acceleration/deceleration or the like of the subject vehicle 101 is controlled so that the inter-vehicle distance detected by the distance detector 54 becomes a target inter-vehicle distance. In a case where the relative speed of the subject vehicle 101 to the preceding vehicle 111 or 112 is high (for example, in a case where the preceding vehicle moves away from the subject vehicle), the subject vehicle may not follow the preceding vehicle even if the inter-vehicle distance is short.

The lateral position detector 55 detects a relative position of the subject vehicle 101 to the division line DL, that is, a distance (lateral distance) from the division line DL in the lane width direction, and is configured by, for example, a camera or a LiDAR included in the external sensor group 1 in FIG. 1. In a case where the absolute position of the subject vehicle 101 can be accurately measured by the position measurement unit 4 and the position information of the division line DL is stored in advance in the memory unit 12, the lateral distance can also be detected using the value measured by the position measurement unit 4.

The signals from the lane change command part 51, the cancellation command part 52, the external detector 53, the distance detector 54, and the lateral position detector 55 are input to the controller 10. Although omitted in the drawing, the signals from a vehicle speed sensor that detects the vehicle speed of the subject vehicle 101 and a yaw rate sensor that detects the posture (direction) of the subject vehicle 101 are also input to the controller 10.

The controller 10 includes a target setting unit 10a that sets a target vehicle to be followed. When the target setting unit 10a sets the first preceding vehicle 111 as a target vehicle during traveling on the first lane LN1, the controller 10 outputs a control signal to the actuators AC for acceleration/deceleration and steering so that an inter-vehicle distance L21 between the subject vehicle 101 and the first preceding vehicle 111 detected by the distance detector 54 becomes a target inter-vehicle distance. In a case where the actuator AC is controlled so that the inter-vehicle distance becomes a target inter-vehicle distance, the actual inter-vehicle distance becomes a predetermined distance Lb (for example, the target inter-vehicle distance) or more as a result. The target inter-vehicle distance is set according to the vehicle speed of the subject vehicle 101 detected by the vehicle speed sensor (internal sensor group 2).

When the lane change command is output by the lane change command part 51, the controller 10 outputs a control signal to the actuator AC so that the subject vehicle 101 performs the lane change traveling according to the target path generated by the action plan generation unit 15 (FIG. 1) by the procedure in FIG. 2A. When the cancellation command part 52 outputs a lane change cancellation command after the start of the lane change operation by the output of the lane change command, the controller 10 determines whether to cancel the lane change according to the relative position of the subject vehicle 101 to the division line DL detected by the lateral position detector 55.

Specifically, it is determined whether a lateral distance L1 between the division line DL on the second lane LN2 side and the wheel (right front wheel) of the subject vehicle 101 closest to the division line DL on the second lane LN2 side, detected by the lateral position detector 55 during traveling on the first lane LN1, is equal to or more than a predetermined value La. When the lateral distance L1 is equal to or more than the predetermined value La, the controller 10 determines to cancel the lane change. In this case, since the degree of progress of the lane change is equal to or less than a predetermined degree and entering the second lane LN2 can be minimized, cancellation of the lane change is determined according to the cancellation command. The predetermined value La is, for example, 0. The predetermined value may be a value larger than 0 (for example, 30 cm) or a value smaller than 0.

When determining to cancel the lane change, the controller 10 generates a travel path (return travel path) for returning to the first lane LN1. In this case, the controller 10 generates the return travel path in consideration of the current vehicle speed, the position in the lane width direction, and the posture (direction) of the subject vehicle 101 to suppress a sudden change in posture (traveling direction) of the subject vehicle 101 while minimizing the entering of the subject vehicle 101 into the second lane LN2. For example, a return travel path that does not cross the division line DL as illustrated in FIG. 3A or a return travel path that crosses the division line DL as illustrated in FIG. 3B is generated.

The target setting unit 10a determines whether the return travel path crosses the division line DL. When it is determined that the return travel path does not cross the division line DL, the first preceding vehicle 111 on the current lane (first lane LN1) is set as a target vehicle to be followed. That is, the first preceding vehicle 111 set as the target vehicle before the start of the lane change operation is continuously set as the target vehicle. Therefore, the distance between the subject vehicle 101 and the first preceding vehicle 111 is kept equal to or more than a predetermined distance. In this case, since the second preceding vehicle 112 is not set as a target vehicle, it is possible to prevent the brake of the subject vehicle 101 from erroneously operating when the subject vehicle 101 approaches the second preceding vehicle 112.

When determining that the return travel path crosses the division line DL, the target setting unit 10a sets the first preceding vehicle 111 on the current lane (first lane LN1) as a target vehicle to be followed until the subject vehicle 101 (for example, the right front wheel) crosses the division line DL, that is, until the lateral distance L1 detected by the lateral position detector 55 is less than the predetermined value La. Then, immediately before the subject vehicle 101 crosses the division line DL or when the subject vehicle crosses the division line DL, in addition to the first preceding vehicle 111, the second preceding vehicle 112 on the adjacent lane (second lane LN2) is set as a target vehicle to be followed.

When both the first preceding vehicle 111 and the second preceding vehicle 112 are set as the target vehicles as described above, the controller 10 determines whether a distance L21 from the subject vehicle 101 to the first preceding vehicle 111 or a distance L22 from the subject vehicle 101 to the second preceding vehicle 112, detected by the distance detector 54, is larger. In case of L21<L22, a control signal is output to the actuator AC so that the distance L21 is equal to or more than the predetermined distance Lb, and in case of L21>L22, a control signal is output to the actuator AC so that the distance L22 is equal to or more than the predetermined distance Lb. As a result, the inter-vehicle distance between the subject vehicle 101 and the preceding vehicle 111 or 112 is kept at least equal to or more than the predetermined distance Lb when the lane change is cancelled.

When the subject vehicle 101 (for example, the right front wheel of the subject vehicle 101) moves to the adjacent lane across the division line DL, and then returns to the current lane across the division line DL, the target setting unit 10a sets the preceding vehicle 111 on the current lane side as a target vehicle. Therefore, the inter-vehicle distance to the preceding vehicle 111 is kept equal to or more than the predetermined distance Lb. In this case, since only the first preceding vehicle 111 is set as the target vehicle, it is possible to prevent the brake of the subject vehicle 101 from erroneously operating in a case where the inter-vehicle distance L22 to the second preceding vehicle 112 is less than the predetermined distance Lb.

When the lane change cancellation command is output by the cancellation command part 52 and the lateral distance L1 detected by the lateral position detector 55 is less than the predetermined value La, the controller 10 determines not to cancel the lane change. Therefore, as illustrated in FIG. 3C, the controller 10 controls the actuator AC so that the subject vehicle 101 changes the lane to the adjacent lane, and the lane change operation is continued.

In a case where the lane change operation is continued without returning as described above, the target setting unit 10a sets both the first preceding vehicle 111 and the second preceding vehicle 112 as target vehicles until the subject vehicle 101 crosses the division line DL. After the subject vehicle 101 crosses the division line DL, only the second preceding vehicle 112 is set as a target vehicle. Therefore, after the subject vehicle 101 crosses the division line DL, the controller 10 controls the actuator AC to follow the second preceding vehicle 112.

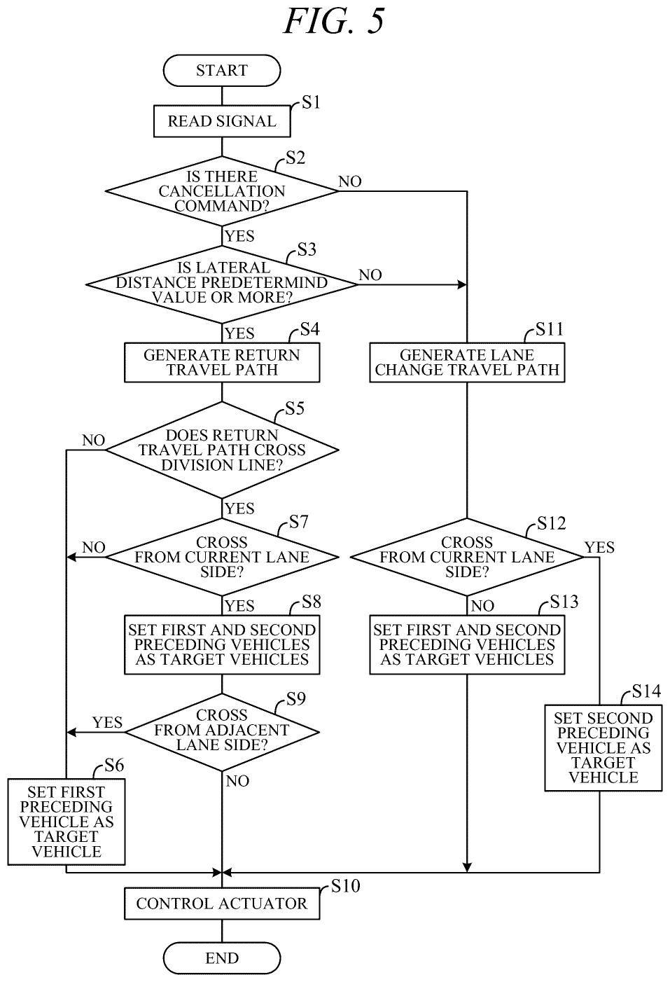

FIG. 5 is a flowchart illustrating an example of the processing executed by the controller 10 in FIG. 4. The processing shown in this flowchart starts when the lane change command from the first lane LN1 to the second lane LN2 is input during the subject vehicle 101 traveling on the first lane LN1 and further when the lateral movement of the subject vehicle 101 at the point P4 in FIG. 2A is started. Then, it is repeated at a predetermined cycle until the lane change operation to the second lane LN2 is completed, or the lane change is canceled and the return operation to the first lane LN1 is completed. It is assumed that preceding vehicles 111 and 112 exist in the first lane LN1 and the second lane LN2, respectively, at the start of the lateral movement.

First, in step S1, signals from the cancellation command part 52 and detectors 53 to 55 are read. In addition, signals from the vehicle speed sensor and the yaw rate sensor are also read in step S1. Next, in step S2, it is determined whether a lane change cancellation command is input by the cancellation command part 52. If an affirmative decision is made in step S2, the process proceeds to step S3, where it is determined whether the lateral distance L1 between the subject vehicle 101 and the division line DL, detected by the lateral position detector 55, is more than or equal to a predetermined value La. At this time, the time until the subject vehicle 101 intersects with the division line DL may be calculated, and whether the calculated time is more than or equal to a predetermined value may be determined. Step S3 is a determination of whether to return the subject vehicle 101 to the first lane LN1.

If an affirmative decision is made in step S3, the process proceeds to step S4 to return the subject vehicle 101. In step S4, based on the current vehicle speed, lateral position or posture in the lane width direction, etc., of the subject vehicle 101 detected by various detectors and sensors, a return travel path when the subject vehicle 101 returns is generated. Next, in step S5, it is determined whether the return travel path crosses the division line DL, for example, whether the return travel path intersects with the division line DL. If a negative decision is made in step S5, the process proceeds to step S6, where the first preceding vehicle 111 in front of the subject vehicle 101 is set as the target vehicle, and then proceeds to step S10.

On the other hand, if an affirmative decision is made in step S5, the process proceeds to step S7. In step S7, it is determined whether the subject vehicle 101 crosses the division line DL from the side of first lane LN1 (current lane), or is about to cross the division line DL. More specifically, the lateral distance L1 from the subject vehicle 101 to the division line DL is detected based on the signal from the lateral position detector 55, and it is determined whether the lateral distance L1 is less than a predetermined value La. This is a determination whether the subject vehicle 101 crosses the division line DL when traveling along the travel path. If an affirmative decision is made in step S7, the process proceeds to step S8, and if a negative decision is made, it proceeds to step S6.

In step S8, both the first preceding vehicle 111 and the second preceding vehicle 112 are set as the target vehicles. Next, in step S9, based on the signal from the lateral position detector 55, it is determined whether the subject vehicle 101 crosses the division line DL from the side of the second lane LN2 (adjacent lane). If an affirmative decision is made in step S9, the process proceeds to step S6, and if a negative decision is made, it proceeds to step S10.

If a negative decision is made in step S3, it is determined that return travel is not possible, and the process proceeds to step S11. The process also proceeds to step S11 if a negative decision is made in step S2. In step S11, based on the vehicle state of the subject vehicle 101 detected by various detectors and sensors, a travel path during lane change of the subject vehicle 101 is generated.

Next, in step S12, similar to step S7, based on the signal from the lateral position detector 55, it is determined whether the subject vehicle 101 crosses the division line DL from the side of the first lane LN1 (current lane), or is about to cross the division line DL. If a negative decision is made in step S12, the process proceeds to step S13, and if an affirmative decision is made, it proceeds to step S14. In step S13, both the first preceding vehicle 111 and the second preceding vehicle 112 are set as the target vehicles, and the process proceeds to step S10. In step S14, the second preceding vehicle 112 is set as the target vehicle, and the process proceeds to step S10.

In step S10, the actuator AC for steering and acceleration/deceleration is controlled so that the subject vehicle 101 travels along the return travel path generated in step S4, or the lane change travel path in step S11. Furthermore, the actuator AC is controlled to follow the target vehicle set in step S6, S8, S13, or S14, that is, to travel at a predetermined distance away from the target vehicle. Especially, when both the first preceding vehicle 111 and the second preceding vehicle 112 are set as the target vehicles in steps S8 and S13, the actuator AC is controlled so that the shorter of the inter-vehicle distances between the subject vehicle and the first preceding vehicle and between the subject vehicle and the second preceding vehicle is more than a predetermined distance. More specifically, the preceding vehicle having a greater degree of approach based on the inter-vehicle distance and relative speed is identified, and the actuator AC is controlled to maintain a minimum inter-vehicle distance to the identified preceding vehicle.

The operation of the present embodiment is summarized as follows. When the driver operates the blinker lever to input a lane change command to the controller 10 while the subject vehicle 101 travels on the first lane LN1, a lane change operation from the first lane LN1 to the second lane LN2 is started as illustrated in FIG. 2A. Thereafter, when another vehicle suddenly approaches from behind on the second lane LN2, a lane change cancellation command is input. In a case where the cancellation command is input before the subject vehicle 101 starts the lateral movement to the second lane LN2 side, the lateral movement is not started, and the subject vehicle 101 follows the first preceding vehicle 111 traveling on the first lane LN1.

In contrast, in a case where, after the start of the lateral movement, the cancellation command is input when the distance (lateral distance L1) between the subject vehicle 101 and the division line DL in the lane width direction is equal to or more than the predetermined value La, a return travel path for the subject vehicle 101 to return to the first lane LN1 is generated (Step S4). As illustrated in FIG. 3A, when it is determined that the return travel path does not cross the division line DL, only the first preceding vehicle 111 on the first lane LN1 is set as a target vehicle to be followed (Step S6). In this case, even when the subject vehicle 101 approaches the second preceding vehicle 112 on the adjacent lane, the travel lanes thereof are different from each other, so that the driver does not feel uneasiness. In addition, since the second preceding vehicle 112 is not a target vehicle to be followed, it is possible to prevent the brake from erroneously operating due to the ACC function operating when the subject vehicle 101 approaches the second preceding vehicle 112.

Meanwhile, as illustrated in FIG. 3B, when it is determined that the return travel path crosses the division line DL, both the first preceding vehicle 111 and the second preceding vehicle 112 are set as target vehicles to be followed when the subject vehicle 101 actually crosses the division line DL (Step S8). Therefore, the traveling operation of the subject vehicle 101 is controlled so that not only the inter-vehicle distance L11 between the subject vehicle 101 and the first preceding vehicle 111 but also the inter-vehicle distance L22 between the subject vehicle 101 and the second preceding vehicle 112 are equal to or more than the predetermined value Lb. When the return travel path crosses the division line DL, the subject vehicle 101 may temporarily approach the second preceding vehicle 112 on the same lane as the second preceding vehicle 112. However, since the inter-vehicle distance L22 is kept equal to or more than the predetermined value Lb, the driver's uneasiness can be suppressed.

When the subject vehicle 101 crosses the division line DL from the first lane LN1 side, and then crosses the division line DL again from the second lane LN2 side, only the first preceding vehicle 111 is set as a target vehicle (Step S9→Step S6). Therefore, it is possible to prevent the brake from erroneously operating due to the ACC function operating when the subject vehicle 101 approaches the second preceding vehicle 112.

In a case where, after the start of the lateral movement to the second lane LN2 side, the cancellation command is input after the lateral distance L1 between the subject vehicle 101 and the division line DL becomes less than the predetermined value La, the cancellation command is not received and the lane change operation is continued as illustrated in FIG. 3C (Step S11). Therefore, the subject vehicle 101 does not suddenly return to the first lane LN1 and the behavior of the vehicle 101 is stabilized. In this case, until the subject vehicle 101 crosses the division line DL, both the first preceding vehicle 111 and the second preceding vehicle 112 are set as target vehicles to be followed, and when the subject vehicle 101 crosses the division line DL, only the second preceding vehicle 112 is set as a target vehicle to be followed (Step S13 and Step S14).

Since the second preceding vehicle 112 is set as a target vehicle before the subject vehicle 101 crosses the division line DL as described above, the lane change operation can be smoothly performed. That is, if the second preceding vehicle 112 is set as a target vehicle after the subject vehicle 101 crosses the division line DL, there is a concern that the subject vehicle 101 may be suddenly braked when the distance between the subject vehicle 101 and the second preceding vehicle 112 is short immediately after crossing the division line DL2. In this regard, in the present embodiment, such sudden braking can be prevented.

According to the present embodiment, the following operations and effects can be achieved.

(1) A driving assistance apparatus 50 includes an external detector 53 that detects an external situation around a subject vehicle 101, a lane change command part 51 that outputs a lane change command from a first lane LN1 on which the subject vehicle 101 is traveling to a second lane LN2 adjacent to the first lane LN1 via a division line DL, a cancellation command part 52 that outputs a cancellation command of the lane change, and a controller 10 that controls an actuator AC for traveling with a preceding vehicle traveling in front of the subject vehicle 101, detected by the external detector 53, as a control target so that an inter-vehicle distance between the subject vehicle 101 and the preceding vehicle is equal to or more than a predetermined value Lb (FIG. 4). When the lane change command is output from the lane change command part 51, the controller 10 executes a lane change operation to change the lane from the first lane LN1 to the second lane LN2, and when the cancellation command of the lane change is output from the cancellation command part 52 after the start of the lane change operation and before the completion of the lane change operation, the controller 10 controls the actuator AC to return to the first lane LN1. The preceding vehicle includes a first preceding vehicle 111 traveling on the first lane LN1 and a second preceding vehicle 112 traveling on the second lane LN2 (FIGS. 3A and 3B). The controller 10 (target setting unit 10a) sets at least one of the first preceding vehicle 111 and the second preceding vehicle 112 as a control target based on the return travel path for the subject vehicle 101 when the cancellation command of the lane change is output and the subject vehicle 101 returns to the first lane LN1 (FIG. 5).

Due to this configuration, when the subject vehicle 101 returns to the first lane LN1 across the division line DL, not only the distance between the subject vehicle 101 and the first preceding vehicle 111 but also the distance between the subject vehicle 101 and the second preceding vehicle 112 can be kept equal to or more than a predetermined distance Lb. Therefore, it is possible to suppress the driver's uneasiness caused due to the subject vehicle 101 approaching the second preceding vehicle 112.

(2) The controller 10 determines whether the return travel path for the subject vehicle 101 crosses the division line DL that is a boundary between the first lane LN1 and the second lane LN2, and sets at least one of the first preceding vehicle 111 and the second preceding vehicle 112 as a control target based on a result of the determination (FIG. 5). Specifically, when it is determined that the return travel path does not cross the division line DL, the first preceding vehicle 111 is set as a control target, and when it is determined that the return travel path crosses the division line DL, both the first preceding vehicle 111 and the second preceding vehicle 112 are set as control targets (FIG. 5). Therefore, an appropriate preceding vehicle can be set as a control target according to the return travel path for the subject vehicle 101.

(3) The driving assistance apparatus 50 further includes a distance detector 54 that detects an inter-vehicle distance L21 between the subject vehicle 101 and the first preceding vehicle 111 and an inter-vehicle distance L22 between the subject vehicle 101 and the second preceding vehicle 112 (FIG. 4). When the second preceding vehicle 112 is positioned behind the first preceding vehicle 111, the controller 10 controls the actuator AC so that the inter-vehicle distance L22 between the subject vehicle 101 and the second preceding vehicle 112 detected by the distance detector 54 is equal to or more than the predetermined value Lb after the subject vehicle 101 crosses the division line DL from the first lane LN1 side, and thereafter, when the subject vehicle 101 crosses the division line DL from the second lane LN2 side, the controller 10 sets the first preceding vehicle 111 as a control target (FIG. 5). Therefore, the traveling operation of the subject vehicle 101 for returning across the division line DL can be appropriately controlled while considering the position of the second preceding vehicle 112 close to the subject vehicle 101.

(4) When the first preceding vehicle 111 is positioned behind the second preceding vehicle 112, the controller 10 controls the actuator AC so that the inter-vehicle distance L21 between the subject vehicle 101 and the first preceding vehicle 111 detected by the distance detector 54 is equal to or more than the predetermined value Lb after the subject vehicle 101 crosses the division line DL from the first lane LN1 side, and thereafter, when the subject vehicle 101 crosses the division line DL from the second lane LN2 side, the controller 10 sets the first preceding vehicle 111 as a control target (FIG. 5). Therefore, the traveling operation of the subject vehicle 101 for returning across the division line DL can be appropriately controlled while considering the position of the first preceding vehicle 111 close to the subject vehicle 101.

(5) After the subject vehicle 101 crosses the division line DL from the first lane LN1 side, the controller 10 controls the actuator AC so that the subject vehicle 101 returns to the first lane LN1, while controlling the actuator AC so that the inter-vehicle distance L21 between the subject vehicle 101 and the first preceding vehicle 111 and the inter-vehicle distance L22 between the subject vehicle 101 and the second preceding vehicle 112 detected by the distance detector 54 are equal to or more than the predetermined value Lb. Therefore, it is possible to appropriately perform the lane-change return operation while performing following traveling.

(6) When the cancellation command of the lane change is output from the cancellation command part 52 after the start of the lane change operation and before the completion of the lane change operation, the controller 10 determines whether to return to the first lane LN1 according to a position of the subject vehicle 101 relative to the division line DL (FIG. 5). Therefore, the return traveling can be smoothly performed without a sudden change of the return travel path.

(7) Specifically, when the cancellation command of the lane change is output from the cancellation command part 52 after the start of the lane change operation and before the completion of the lane change operation, it is determined whether a distance (lateral distance L1) from the subject vehicle 101 to the division line DL is less than a predetermined value La based on a value detected by a lateral position detector 55, and when it is determined that the distance is less than the predetermined value La, the actuator AC is controlled to perform the lane change to the second lane LN2 (FIG. 5). As described above, the lane change is not necessarily cancelled even if the lane change cancellation command is output, so that the behavior of the subject vehicle 101 can be stabilized.

(8) When the cancellation command of the lane change is output from the cancellation command part 52 after the start of the lane change operation and before the completion of the lane change operation and it is determined that the lateral distance L1 from the subject vehicle 101 to the division line DL is less than the predetermined value La, the controller 10 sets both the first preceding vehicle 111 and the second preceding vehicle 112 as control targets until the subject vehicle 101 crosses the division line DL, and after the subject vehicle 101 crosses the division line DL, the controller 10 sets the second preceding vehicle 112 as a control target (FIG. 5). Therefore, in a case where the lane change is not canceled, the driver can be prevented from feeling uneasiness due to the shortening inter-vehicle distance to the approaching preceding vehicle.

(9) The controller 10 sets the first lane LN1 or the second lane LN2 as a target lane for the subject vehicle 101 according to a position of the subject vehicle 101 relative to the division line DL when the cancellation command of the lane change is output from the cancellation command part 52 after the start of the lane change operation and before the completion of the lane change operation. That is, in a case where the return traveling is performed, the first lane LN1 is set as the target lane, and in a case where the return traveling is not performed, the second lane LN2 is set as the target lane. Further, the controller 10 controls the actuator AC based on a center position of the target lane in the lane width direction and a position of the preceding vehicle set as the control target in the traveling direction. That is, the actuator AC is controlled so that the subject vehicle 101 moves to the center position of the target lane in the lane width direction while the inter-vehicle distances L21 and L22 to the preceding vehicle are kept equal to or more than the predetermined value Lb. Therefore, it is possible to appropriately realize the lane change operation including the lane-change return operation without increasing the driver's uneasiness.

(10) When the driver of the subject vehicle 101 operates a blinker lever in a predetermined mode, the lane change command part 51 output the lane change command. Thus, the lane change can be realized at a timing desired by the driver. The lane change command part 51 can also output the lane change command based on the external situation detected by the external detector 53. Therefore, the lane change can be realized at an optimum timing in consideration of the external situation.

The above embodiment can be varied into various forms. Some variations will be described below. In the above embodiment, the controller 10 (target setting unit 10a) as the driving control unit sets at least one of the first preceding vehicle 111 and the second preceding vehicle 112 as a control target for following based on the return travel path of the subject vehicle 101 when returning to the first lane LN1 after the cancellation command of the lane change is output. However, it may also be possible to switch the control target between the first preceding vehicle 111 and the second preceding vehicle 112 according to a change of the travel lane of the subject vehicle 101 between the first lane LN1 and the second lane LN2. For example, when the travel lane is changed to the second lane LN2 by crossing the division line DL from the first lane LN1 side, both the first preceding vehicle 111 and the second preceding vehicle 112 may be set as target vehicles, and when the travel lane is changed to the first lane LN1 by crossing the division line DL from the second lane LN2 side, the first preceding vehicle 111 may be set as a target vehicle.

In the above embodiment, the external situation around the subject vehicle 101 is detected by an external detector 53 (an external detection part) such as a camera. However, the external detection part may also be a LiDAR or radar. In the above embodiment, a lane change command from the first lane to the second lane is output from the lane change command part 51, and a cancellation command of the lane change is output from the cancellation command part 52. However, the configurations of these command parts can be any configurations. In the above embodiment, an example of changing lanes from the first lane LN1 to the second lane LN2, which is on the right side in the traveling direction of the first lane LN1, is described. However, the invention can also be applied similarly in a case of changing lanes from the first lane to the second lane LN2, which is on the left side in the traveling direction of the first lane LN1. That is, a positional relationship in the left-right direction between the first lane on which the subject vehicle is traveling and the second lane adjacent to the first lane, is not limited to the above relationship.

In the above embodiment, an example where the first preceding vehicle 111 traveling on the first lane LN1 and the second preceding vehicle 112 traveling on the second lane LN2 run side by side is shown (FIGS. 3A to 3C). However, the invention can also be applied similarly even when the first preceding vehicle 111 is ahead of the second preceding vehicle 112 or the second preceding vehicle 112 is ahead of the first preceding vehicle 111. In the above embodiment, it is determined whether the return travel path when the lane change is canceled crosses the division line DL, and based on the determination result, at least one of the first preceding vehicle 111 and the second preceding vehicle 112 is set as a control target. However, instead of using the return travel path as it is, the control target may be set according to whether a corrected return travel path crosses the division line DL.

In the above embodiment, the inter-vehicle distance L21 between the subject vehicle 101 and the first preceding vehicle 111 and the inter-vehicle distance L22 between the subject vehicle 101 and the second preceding vehicle 112 are detected by a distance detector 54 (a distance detection part) such as a radar or LiDAR. However, the distance detection part may also be a camera. In the above embodiment, when the cancellation command of the lane change is output, it is determined whether to return to the first lane LN1 based on whether the lateral distance L1 from the subject vehicle 101 to the division line DL is more than or equal to a predetermined value La. However, as long as determining whether to return in accordance with a position of the subject vehicle 101 relative to the division line DL, another criteria may be used.

In the above embodiment, an example of applying the driving assistance apparatus 50 to a self-driving vehicle is described. However, the present invention can also be applied to a manual driving vehicle with a driving assistance function.

The above explanation is an explanation as an example and the present invention is not limited to the above embodiment or modifications unless sacrificing the characteristics of the invention. The above embodiment can be combined as desired with one or more of the above modifications. The modifications can also be combined with one another.

### REFERENCE SIGNS LOST

10 controller, 10a target setting unit, 50 driving assistance apparatus, 51 lane change command part, 52 cancellation command part, 53 external detector, 54 distance detector, 55 lateral position detector, AC actuator

1. A driving assistance apparatus, comprising:
an external detection part configured to detect an external situation around a subject vehicle;
a command part configured to output a lane change command from a first lane on which the subject vehicle travels to a second lane adjacent to the first lane through a division line, and a cancellation command of the lane change; and
a driving control unit configured to control an actuator for traveling so that an inter-vehicle distance between the subject vehicle and a preceding vehicle traveling ahead of the subject vehicle and detected by the external detection part is equal to or more than a predetermined value, with the preceding vehicle as a control target for the subject vehicle, and when the lane change command is output from the command part, to control the actuator so as to perform a lane change operation changing a lane from the first lane to the second lane, and further after a start of the lane change operation, when the cancellation command of the lane change is output from the command part before a completion of the lane change operation, to control the actuator so as to return to the first lane, wherein
the preceding vehicle includes a first preceding vehicle traveling on the first lane and a second preceding vehicle traveling on the second lane, and
the driving control unit is configured to set at least one of the first preceding vehicle and the second preceding vehicle as the control target based on a return travel path for the subject vehicle when the cancellation command of the lane change is output and the subject vehicle returns to the first lane.

2. The driving assistance apparatus according to claim 1, wherein
the driving control unit is configured to determine whether the return travel path crosses the division line as a boundary between the first lane and the second lane, and set the at least one of the first preceding vehicle and the second preceding vehicle as the control target based on a determination result.

3. The driving assistance apparatus according to claim 2, wherein
the driving control unit is configured to set the first preceding vehicle as the control target when it is determined that the return travel path does not cross the division line, and to set both the first preceding vehicle and the second preceding vehicle when it is determined that the return travel path crosses the division line.

4. The driving assistance apparatus according to claim 3, further comprising
a distance detection part configured to detect an inter-vehicle distance between the subject vehicle and the first preceding vehicle and an inter-vehicle distance between the subject vehicle and the second preceding vehicle, wherein
when the second preceding vehicle is positioned behind the first preceding vehicle, the driving control unit is configured to control the actuator so that the inter-vehicle distance between the subject vehicle and the second preceding vehicle detected by the distance detection part is equal to or more than the predetermined value after the subject vehicle crosses the division line from a side of the first lane, and to set the first preceding vehicle as the control target when the subject vehicle crosses the division line from a side of the second lane after the subject vehicle crosses the division line from the side of the first lane.

5. The driving assistance apparatus according to claim 4, wherein
when the first preceding vehicle is positioned behind the second preceding vehicle, the driving control unit is configured to control the actuator so that the inter-vehicle distance between the subject vehicle and the first preceding vehicle detected by the distance detection part is equal to or more than the predetermined value after the subject vehicle crosses the division line from the side of the first lane, and to set the first preceding vehicle as the control target when the subject vehicle crosses the division line from the side of the second lane after the subject vehicle crosses the division line from the side of the first lane.

6. The driving assistance apparatus according to claim 3, further comprising
a distance detection part configured to detect an inter-vehicle distance between the subject vehicle and the first preceding vehicle and an inter-vehicle distance between the subject vehicle and the second preceding vehicle, wherein
the driving control unit is configured to control the actuator so that the subject vehicle returns to the first lane while controlling the actuator so that the inter-vehicle distance between the subject vehicle and the first preceding vehicle and the inter-vehicle distance between the subject vehicle and the second preceding vehicle detected by the distance detection part is equal to or more than the predetermined value, after the subject vehicle crosses the division line from a side of the first lane.

7. The driving assistance apparatus according to any one of claims 1 to 6, wherein
after the start of the lane change operation, the driving control unit is configured to determine whether to return to the first lane in accordance with a position of the subject vehicle relative to the division line when the cancellation command of the lane change is output from the command part before the completion of the lane change operation.

8. The driving assistance apparatus according to claim 7, wherein
after the start of the lane change operation, the driving control unit is configured to determine whether a distance from the subject vehicle to the division line is less than a predetermined value when the cancellation command of the lane change is output from the command part before the completion of the lane change operation, and to control the actuator so as to change the lane to the second lane when it is determined that the distance is less than the predetermined value.

9. The driving assistance apparatus according to claim 8, wherein
after the start of the lane change operation, the driving control unit is configured to set both the first preceding vehicle and the second preceding vehicle as the control target until the subject vehicle crosses the division line when the cancellation command of the lane change is output from the command part before the completion of the lane change operation and it is determined that the distance from the subject vehicle to the division line is less than the predetermined value, and to set the second preceding vehicle as the control target after the subject vehicle crosses the division line.

10. The driving assistance apparatus according to any one of claims 1 to 9, wherein
after the start of the lane change operation, the driving control unit is configured to set the first lane or the second lane as a target lane for the subject vehicle in accordance with a position of the subject vehicle relative to the division line when the cancellation command of the lane change is output from the command part before the completion of the lane change operation, and to control the actuator based on a center position of the target lane in a lane width direction and a position in a traveling direction of the preceding vehicle set as the control target.

11. The driving assistance apparatus according to any one of claims 1 to 10, wherein
the command part is configured to output the lane change command when the lane change is instructed by an occupant of the subject vehicle, or, the lane change is instructed based on the external situation detected by the external detection part.

12. A driving assistance apparatus, comprising:
an external detection part configured to detect an external situation around a subject vehicle;
a command part configured to output a lane change command from a first lane on which the subject vehicle travels to a second lane adjacent to the first lane through a division line, and a cancellation command of the lane change; and
a driving control unit configured to control an actuator for traveling so that an inter-vehicle distance between the subject vehicle and a preceding vehicle traveling ahead of the subject vehicle and detected by the external detection part is equal to or more than a predetermined value, with the preceding vehicle as a control target for the subject vehicle, and when the lane change command is output from the command part, to control the actuator so as to perform a lane change operation changing a lane from the first lane to the second lane, and further after a start of the lane change operation, when the cancellation command of the lane change command is output from the command part before a completion of the lane change operation, to control the actuator so as to return to the first lane, wherein
the preceding vehicle includes a first preceding vehicle traveling on the first lane and a second preceding vehicle traveling on the second lane, and
the driving control unit is configured to switch the control target between the first preceding vehicle ant the second preceding vehicle in accordance with a change of a travel lane for the subject vehicle between the first lane and the second lane.
